(19) United States
(12) Patent Application Publication
(10) Pub. No.: US 2015/0207811 A1
(43) Pub. Date: Jul. 23, 2015

(54) VULNERABILITY VECTOR INFORMATION ANALYSIS

(71) Applicant: HEWLETT-PACKARD DEVELOPMENT COMPANY, L.P., Houston, TX (US)

(72) Inventors: Ben Feher, Ashdod (IL); Ofer Shezaf, Kibbutz Yiftah (IL)

(21) Appl. No.: 14/418,863

(22) PCT Filed: Jul. 31, 2012
(86) PCT No.: PCT/US2012/049043

§ 371 Date: Jan. 30, 2015

(51) Int. Cl. H04L 29/06

(52) U.S. Cl. CPC H04L 63/1433; H04L 63/20

(57) ABSTRACT

Analyzing vulnerability vector information includes collecting information for a test performed by a vulnerability assessment tool to detect a vulnerability. Attributes of the test are determined from the collected information and are used to determine if there any matches with information in a security vulnerabilities information source.

### BACKGROUND

Information security vulnerabilities are one of the major sources of security risks managed by system administrators. Some vulnerabilities may expose a network and its systems to unauthorized access to information or other malicious activities. Many tools exist to detect vulnerabilities, and an organization may use multiple tools to perform such operations.

### BRIEF DESCRIPTION OF DRAWINGS

The embodiments are described in detail with reference to the examples shown in the following figures:

FIG. 1 illustrates a vulnerability management system;

FIG. 2 illustrates an example of data extracted and matched;

FIG. 3 illustrates a computer system that may be used as a platform for the vulnerability management system; and

FIG. 4 illustrates a method of matching.

### DETAILED DESCRIPTION OF EMBODIMENTS

For simplicity and illustrative purposes, the principles of the embodiments are described by referring mainly to examples thereof. In the following description, numerous specific details are set forth in order to provide a thorough understanding of the embodiments. It is apparent that the embodiments may be practiced without limitation to all the specific details. Also, the embodiments may be used together in various combinations.

According to an embodiment, a vulnerability management system collects information about tests that can be executed by multiple different vulnerability assessment tools. The collected information may be referred to as a vulnerability vector. The tests may include the operations performed by a scanner to detect different vulnerabilities. The scanner may scan computers, network devices, etc., in a computer network to detect vulnerabilities. Attributes of the tests are extracted from the collected information and are compared to information from a security vulnerabilities information source (e.g., Common Vulnerabilities and Exposures (CVE), which is a dictionary of publicly known information security vulnerabilities and exposures maintained by an organization). The comparison may be performed to determine whether the tests of the vulnerability assessment tools are associated with specific vulnerabilities described in the information provided by the security vulnerabilities information source. If matches are found, the matches may be stored in a vulnerability management data storage system. The vulnerability management data storage system may be subsequently queried to determine additional information about vulnerabilities that may be detected by any of the vulnerability assessment tools, including remedial information that may specify priorities and fixes, such as patches, for the vulnerabilities.

A vulnerability may include an action that can be performed on a computer system that violates a security policy or rule related to the security of information and/or the security of a computer system. For example, a policy may restrict a user group to only access certain directories in a file system. An example of a rule may include that remote execution of a command can only be performed by a user with a system administrator ID. A vulnerability may exist if an application allows someone to execute a remote command under a non-system administrator ID. Examples of vulnerabilities may include allowing remote execution of commands by another user, unauthorized data access contrary to specified restrictions, facilitating a denial of service (e.g., by flooding), etc.

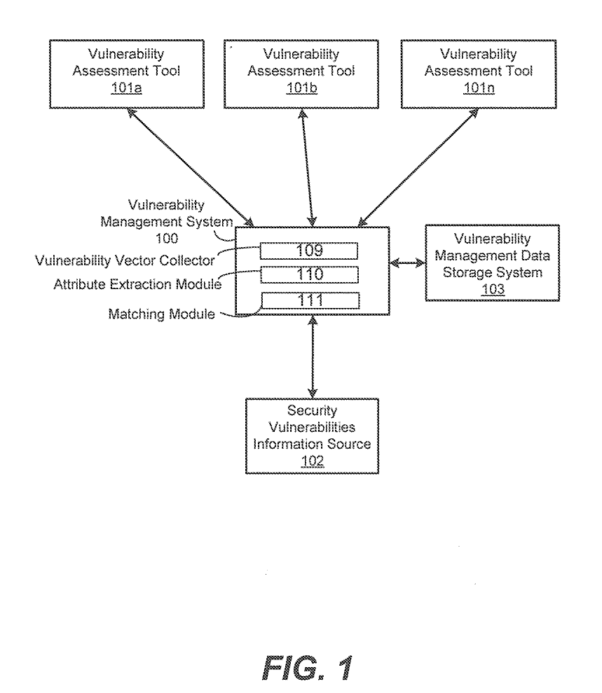

FIG. 1 shows a vulnerability management system 100 that may include a vulnerability vector collector 109, an attribute extraction module 110 and a matching module 111. For example, the vulnerability vector collector 109 collects information about tests that may be performed by the vulnerability assessment tools 101 (shown as 101a-n) to detect vulnerabilities. The vulnerability vector collector 109 may retrieve the information about the tests from libraries or other data structures used by the vulnerability assessment tools 101. The information about the tests may include descriptive text describing the tests, titles of the tests, information describing signatures and rules, and logic, which may be comprised of computer code or scripts executed by a tool to detect a vulnerability, and other information. In some instances some of the information may be unavailable, such as the logic, but the remaining information may be used for matching. The vulnerability assessment tools 101 may comprise scanners that run the tests. A scanner may include a computer program comprised of machine readable instructions to run the tests. The tests may assess computers, networks or applications. The scanners may detect different types of vulnerabilities, such as vulnerabilities related to configuration settings, database vulnerabilities, application vulnerabilities, etc.

The attribute extraction module 110 determines attributes associated with the tests from the information collected from the vulnerability assessment tools 101. Examples of the attributes include an identifier of a system that is vulnerable or causing a vulnerability, a vulnerability location, vulnerability type, date, etc. A vulnerability location may include a uniform resource location (URL), file location, or other data storage location. Vulnerability type is a category of vulnerabilities, such as SQL injection (related to database vulnerabilities), cross-site scripting (related to web application vulnerabilities), etc.

The attribute extraction module 110 may employ one or more extraction techniques to determine the attributes of the tests from text and logic collected from the vulnerability assessment tools 101. Examples of the extraction techniques are now described. Attributes may be directly available as a field in a database or some other data structure, such as a field identifying a vulnerable system or a categorization referring to a vulnerability type. Pattern matching may be used to determine structural elements, such as a uniform resource indicator (URI) from which a web page and attribute can be determined by parsing. A list of values or patterns for vulnerability types or names of products can be searched for in descriptive text. In another example, which may be applied to a title of a test, previously identified values of attributes may be removed from the title and the remaining portion may be assumed to be the non-identified attributes. For example, once a URI and an attack type are removed from a title, the rest may refer to a system or product name. This enables learning of new patterns used to further search field values.

The matching module 111 determines whether there are any matches between the tests which may be performed by the vulnerability assessment tools 101 and the information in the security vulnerabilities information source 102. The security vulnerabilities information source 102 may include an information source maintaining and making available information associated with known vulnerabilities. The security vulnerabilities information source 102 may be a reputable source that is well recognized and used by industry. The security vulnerabilities information source 102 may compile information from multiple sources to operate as a repository for known vulnerabilities. In one example, the security vulnerabilities information source 102 is CVE. CVE is a dictionary of publicly known information security vulnerabilities and exposures maintained by the MITRE organization. The CVE or another type of security vulnerabilities information source 102 may include entries for vulnerabilities. The entries may include text comprised of an overview describing the vulnerability; an impact of the vulnerability describing the effects on systems and its users; references to advisories, solutions, and tools; vulnerable software and versions; and/or technical details.

The matching module 111 may use the attributes determined by the attribute extraction module 110 of a test for a comparison to the entries in the security vulnerabilities information source 102. For example, the attributes may be used to query the entries in the security vulnerabilities information source 102 for matches. For example, system name, vulnerability location and vulnerability type are determined by the attribute extraction module 110 for a particular test performed by the vulnerability assessment tool 101a. The matching module 111 determines if these three attributes are also found in an entry in the security vulnerabilities information source 102. If all three attributes are found in an entry, then the entry is considered a match. String searching techniques, such as Naïve string searching or finite-state automaton may be used to identify matches.

In one example, even if all the attributes cannot be identified in an entry of the security vulnerabilities information source 102, a match may still be identified. For example, system name, vulnerability location and vulnerability type are the attributes being compared to the entries. If only two of the attributes are found in an entry, the entry may still be considered a match. In another example, a partial match for an attribute may be considered a match for that attribute. For example, the URL extracted from description of a test provided by the vulnerability assessment tool 101a partially matches a vulnerability location in an entry in the security vulnerabilities information source 102. The partial match may be considered a match if most of the characters match. In another example, a hierarchal taxonomy of vulnerability types is used to determine matches. For example, if a parent or a child of an entry has a matching attribute, then the entry may be considered a match. In another example, a level of matching is determined if a fuzzy matching function is employed. If the level is above a threshold, the result is assumed to be a match and if below a threshold, the potential match may be presented for further manual verification.

If a match is identified, a matching entry ID for the matching entry and other information for the matching entry may be stored in the vulnerability management data storage system 103. Also, information for the test corresponding to the matching entry may also be stored in the vulnerability management data storage system 103. The vulnerability management data storage system 103 may comprise a database or some other type of data storage system. The information for matching entries that is stored in the vulnerability management data storage system 103 may be used for vulnerability management, patch management, vulnerability alerting and intrusion detection. For example, the vulnerability management system 100 may send alerts to system administrators if a vulnerability is detected, and the alerts may include information retrieved from the vulnerability management data storage system 103 that is related to the detected vulnerability. The vulnerability management system 100 may also generate reports based on information stored in the vulnerability management data storage system 103. In another example, a CVE ID is retrieved from the vulnerability management data storage system 103 for a detected vulnerability. The CVE ID is used in searches of the Internet or databases to identify up-to-date patches and other remedial actions.

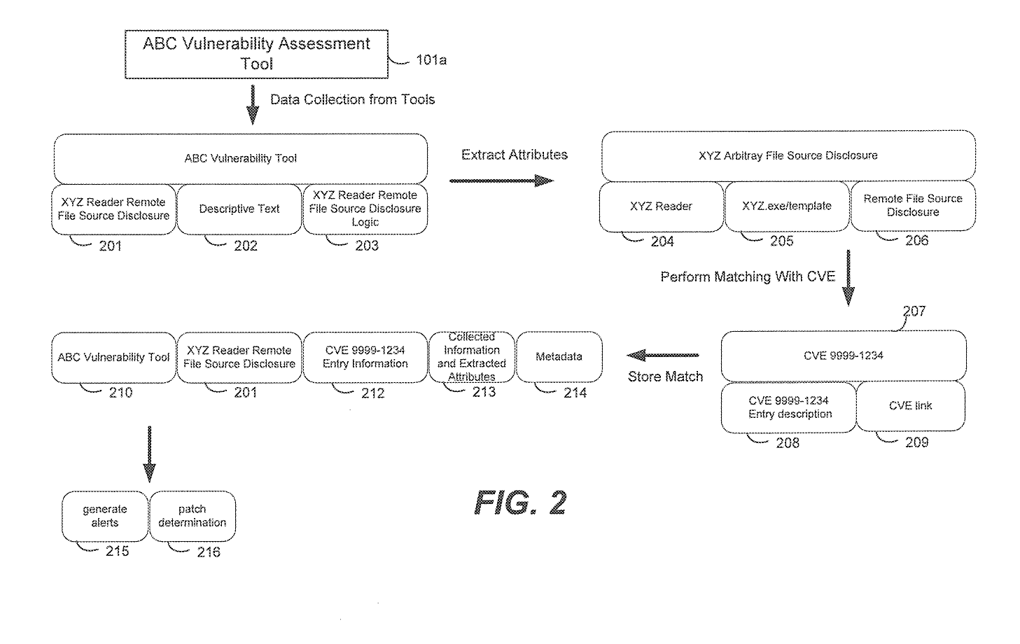

An example of the matching performed by the vulnerability management system 100 is now described with respect to FIG. 2. The vulnerability management system 100 receives information for tests performed by the vulnerability assessment tools 101. The information may be stored in the vulnerability management data storage system 103. As discussed above, the information may include titles, short descriptions, logic, etc., for the tests performed by the vulnerability assessment tools 101. In the example shown in FIG. 2, information for a test performed by the vulnerability assessment tool 101a is collected, for example by the vulnerability vector collector 109. The tool 101a is the ABC vulnerability tool. The information may include a title 201 for the test, descriptive text 202 describing the test, and logic 203 for the test, which may include a script that is executed by the scanner of the tool. The title 201 in this example is “XYZ Reader Remote File Source Disclosure”.

Attributes for the XYZ Reader Remote File Source Disclosure test are extracted. For example, the attribute extraction module 110 attempts to determine attributes for the test, such as system name 204, vulnerability location 205 and vulnerability type 206. For example, regular expression is used to compare text in the title 201 to a list of system names provided in the CVE or a list of vulnerability types provided in the CVE, assuming the CVE is used as the security vulnerabilities information source 102. Assume the attribute extraction module 110 identifies a vulnerability type. For example, the matching vulnerability type 206 is “Remote File Source Disclosure”. The remaining portion of the title 201 is compared to system names stored in the CVE for the “Remote File Source Disclosure” vulnerability type. In this example, a matching system name 204 is found in the CVE, e.g., “XYZ Reader” is the matching system name. Thus, two attributes are determined the test 201.

In addition to descriptive text, the vulnerability assessment tool 101a may also provide logic for performing the test. The attribute extraction module 110 may extract vulnerability location from the logic. For example, the logic may include a script including CGI/XYZ.exe?template=c:\boot.ini. From this information, the vulnerability location URL 205 is determined.

The matching module 111 may determine whether one or more entries in the CVE include the extracted attributes to identify matching entries. In this example, a matching CVE entry 207 is found and has a CVE ID 9999-1234. The CVE entry 207 may include description information 208 for the vulnerability associated with the CVE ID 9999-1234. A link to 209 to the entry may be generated and stored. The description information 208 may include a title of the vulnerability, description, remedial actions, source of information, date last revised, etc.

The information for the test 201, the extracted attributes and information for the matching entry may be stored in the vulnerability management data storage system 103. For example, as shown in FIG. 2, the stored information may include the vulnerability assessment tool name 210, the test title 201, the matching CVE information including CVE ID 212, the collected information for the test and the extracted attributes 213 and metadata 214. The metadata 214 may indicate if a match was found and the date of when the matching was performed. The information stored in the vulnerability management data storage system 103 may be used for a variety of practical applications, such as generating alerts 215, which may include determining alert destinations and sending alerts to the destinations if a vulnerability is detected, and patch determination 216. For example, for patch determination 216, a CVE ID may be determined for a vulnerability from information in the vulnerability management data storage system 103. The CVE ID may be used to search for the most up-to-date patches on the Internet or identify other remedial actions for the vulnerability.

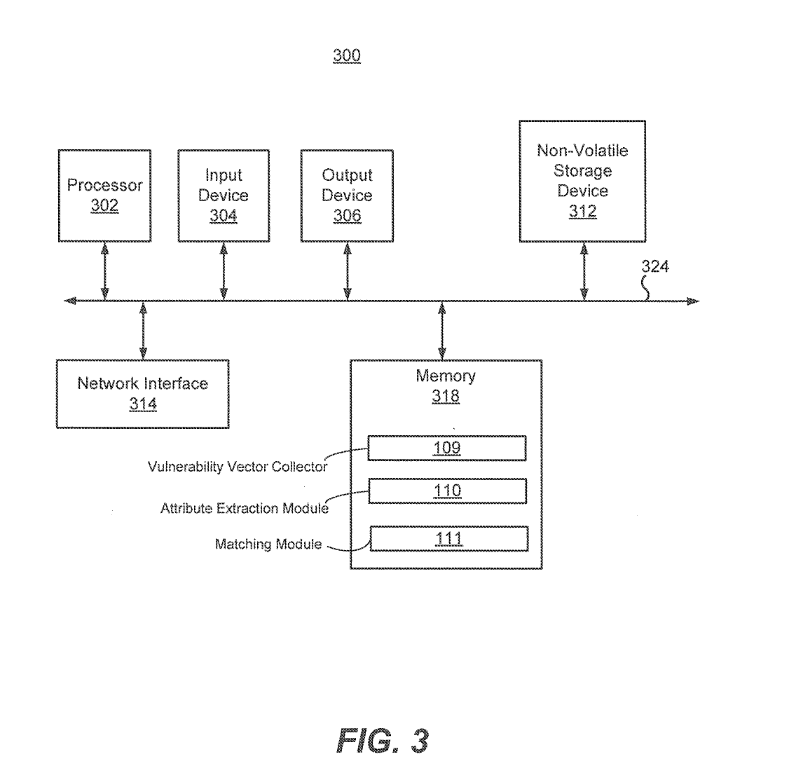

FIG. 3 shows a block diagram of a computer system 300 that may be used for a platform for the vulnerability management system 100. The computer system 300 is shown comprising hardware elements that may be electrically coupled via a bus 324. The hardware elements may include a processor 302, an input device 304 (e.g., keyboard, touchscreen, etc.), and an output device 306 (e.g., display, speaker, etc.). The computer system 300 may also include storage devices, such as memory 318 and a non-volatile storage device 312 (e.g., solid state storage, hard disk, etc.). The storage device 312 and memory 318 are examples of non-transitory computer readable storage media that may store machine readable instructions. For example, the components of the system 100 shown in FIG. 1 may comprise machine readable instructions stored at runtime in the memory 318 and executed by the processor 302. Also, the methods and functions and operations described herein may be embodied ad machine readable instructions that can be executed by the processor 302 to perform the methods and functions and operations. The vulnerability vector collector 109, the attribute extraction module 110 and the matching module 111 are shown in the memory 318 for runtime operation. The non-volatile storage device 312 may store data and applications. The computer system 300 may additionally include a network interface 314, which may be wireless and/or a wired network interface. The computer system 300 may communicate with the vulnerability assessment tools 101 and the security vulnerabilities information source 102, shown in FIG. 1, via the network interface 314. The vulnerability management data storage system 103 shown in FIG. 1 may be hosted with the vulnerability management system 100 or may be hosted on another device, such as a database server, whereby the computer system 300 may connect to the vulnerability management data storage system 103 via the network interface 314. It should be appreciated that the computer system 300 may have numerous variations from that described above. For example, customized hardware might also be used and/or particular elements might be implemented in hardware, software (including portable software, such as applets), or both.

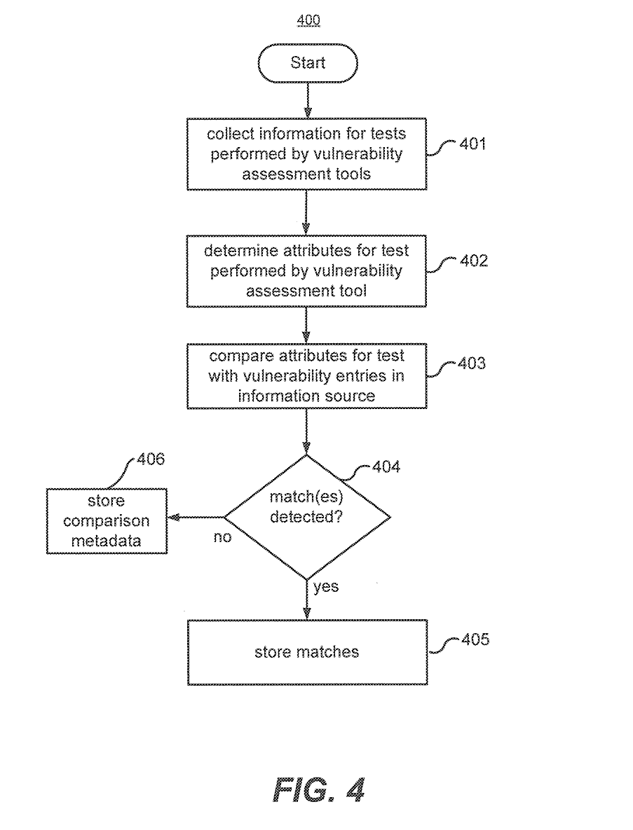

FIG. 4 shows an example of a method 400 of analyzing vulnerability vector information to determine matches with an security vulnerabilities information source. The method 400 is described with respect to the vulnerability management system 100 shown in FIG. 1 by way of example. The method 400 may be performed by other systems.

At 401, the vulnerability management system 100 collects information for one or more tests performed by vulnerability assessment tools 101 to detect vulnerabilities. For example, the vulnerability vector collector 109 may retrieve information from databases or libraries or other predetermined locations storing information describing the tests and storing the logic for performing the tests. The information may be stored in the vulnerability manage data storage system 103 shown in FIG. 1.

At 402, the vulnerability management system 100 determines attributes of a test from the collected information. The vulnerability management system 100 may determine attributes for each test for which it receives information.

In one example, the attribute extraction module 110 shown in FIG. 1 determines the attributes for a test by extracting information from fields in descriptive text and storing the extracted information as the attributes. For example, if the descriptive information for a test includes a field for system name, then that attribute is extracted from its field. In another example, the attribute extraction module 110 determines the attributes for a test by performing pattern matching on structural elements of an attribute. For example, the vulnerability attribute may include a URL with structural elements in its syntax, such as backslashes or other characters or groups of characters commonly found in URLs for locations. These structural elements are identified to extract the URL from the collected information.

In yet another example, the attribute extraction module 110 determines the attributes for a test by comparing the collected information to predetermined values of the attributes. For example, the security vulnerabilities information source 102 may include a list of all the vulnerability types. Text in the collected information may be compared to the vulnerability types to determine if it includes a vulnerability type attribute. In yet another example, the attribute extraction module 110 determines the attributes for a test by identifying a vulnerability location or a vulnerability type from a title of the test. The attribute extraction module 110 assumes a remaining portion of the title corresponds to an identifier of a system that is vulnerable or causing the vulnerability. Two or more of the attribute extraction examples may be performed in combination to determine the attributes.

At 403, the vulnerability management system 100 compares the attributes with information in the security vulnerabilities information source 102 describing predetermined vulnerabilities. The vulnerability management system 100 may query the information describing the predetermined vulnerabilities from the security vulnerabilities information source 102. The security vulnerabilities information source 102 may store entries for the predetermined vulnerabilities. Each entry may include information associated with a predetermined vulnerability, such as ID number, title, description, remedial action, date of last update, etc.

At 404, the vulnerability management system 100 determines from the comparison whether there is a match. For example, the matching module 111 determines whether the attributes are in information describing vulnerability that is stored in the security vulnerabilities information source 102. The security vulnerabilities information source 102 may include an entry for each of a plurality of predetermined vulnerabilities and the matching module 111 may determine whether the attributes or some of the attributes are in an entry for a predetermined vulnerability to detect a match.

The matching module 111 may determine from the comparison whether the attributes match an entry using one or more matching techniques. For example, the matching module 111 may determine that some but not all the attributes are in an entry, but that entry may be considered a match, for example, if a majority of the attributes are in the entry. In another example, the matching module 111 may determine whether the attributes match an entry of the entries in the security vulnerabilities information source by determining whether text for an attribute is partially included in the entry, and if the text for the attribute is partially included in the entry, determining the attribute is in the entry. In yet another example, the matching module 111 may determine whether the attributes match an entry of the entries in the security vulnerabilities information source by comparing an attribute to a hierarchal taxonomy in the security vulnerabilities information source 102, and determining the attribute is in the entry if a parent or child of the entry in the security vulnerabilities information source 102 includes the one of the attributes. For example, the security vulnerabilities information source 102 may store parent child relationships between vulnerabilities that are related. If a vulnerability described in an entry has two attributes of a test and its child has a third attribute of the test, then the entry may be considered a match for the test.

At 405, if a match is found in the information from the security vulnerabilities information source 102 for a predetermined attribute, the information may be stored in the vulnerability management data storage system 103 along with the information for the test determined from the vulnerability assessment tool 101a. For example, the vulnerabilities information source 102 may include a database, and a row is associated with a test and a vulnerability the test can detect. That row may include the information collected from the vulnerability assessment tool running the test and also include information from the matching entry in the security vulnerabilities information source 102, such as the CVE ID (if CVE is the source 102), patches, etc. The information in the vulnerabilities information source 102 for tests and vulnerabilities may be updated to include information from many sources, including many different vulnerability assessment tools. Furthermore, the security vulnerabilities information source 102 may be periodically updated to include the most recent information from the sources. For example, the CVE ID may be used to search the Internet or databases for the most recent information and remedial actions, which may include the most recent patches to fix the vulnerability. The security vulnerabilities information source 102 may operate as a global information source for vulnerabilities that brings together information from a variety of disparate sources. For example, if a vulnerability is detected, the security vulnerabilities information source 102 may be queried to determine the most up-to-date patch or other remedial information to remediate the detected vulnerability. Then, the patch may be downloaded and installed to fix the vulnerability.

More than one matching entry may be identified at 405. Each matching entry may be associated with the test and stored in the vulnerability management data storage system 103 or a subset of the matching entries may be associated with the test and stored in the vulnerability management data storage system 103. For example, the entries may have priorities, such as severe, average and mild. The highest priority entries may be stored in the vulnerability management data storage system 103.

At 406, if no entries match, then information for the test determined from the vulnerability assessment tool may be stored in the vulnerability management data storage system 103. Also, comparison metadata may be stored with the information for the test. The comparison metadata may indicate that no match was found for the test and the date the “no match” determination was made. Therefore, the comparison at 403 and 404 may be performed again at a subsequent date to detect any updates associated with the test.

While the embodiments have been described with reference to examples, various modifications to the described embodiments may be made without departing from the scope of the claimed embodiments.

What is claimed is:

1. A method of analyzing vulnerability vector information comprising:
collecting information for a test performed by a vulnerability assessment tool to detect a vulnerability;
determining attributes of the test from the collected information;
comparing, by a processor, the attributes with entries in a security vulnerabilities information source describing vulnerabilities;
determining, from the comparison, whether the attributes match an entry of the entries in the security vulnerabilities information source for one of the vulnerabilities; and
if a matching entry is determined, storing information from the matching entry with the collected information in a vulnerability management data storage system.

2. The method of claim 1, wherein if a matching entry is not identified from the entries in the security vulnerabilities information source, storing an indication of no matching entry and a date of a determination of no matching entry with the collected information in the vulnerability management data storage system.

3. The method of claim 1, wherein the attributes comprise an identifier of a system that is vulnerable or causing the vulnerability, a vulnerability location, and a vulnerability type.

4. The method of claim 1, wherein the vulnerability detectable by the vulnerability assessment tool comprises an action performable on a computer system that violates a security policy or rule related to security of information stored on a computer system.

5. The method of claim 1, wherein the determining of the attributes comprises:
extracting information from fields in a descriptive text; and
storing the extracted information as one of the attributes.

6. The method of claim 1, wherein the determining of the attributes comprises pattern matching structural elements of one of the attributes with the collected information.

7. The method of claim 1, wherein the determining of the attributes comprises comparing the collected information to predetermined values of the attributes.

8. The method of claim 1, wherein the collected information comprises a title of the test, and the determining of the attributes comprises:
identifying a vulnerability location or a vulnerability type from the title; and
assuming a remaining portion of the title, not including the vulnerability location or the vulnerability type, corresponds to an identifier of a system that is vulnerable or causing the vulnerability.

9. The method of claim 1, wherein the determining of the attributes comprises determining one of the attributes from logic used by the vulnerability assessment tool to execute the test to detect the vulnerability.

10. The method of claim 1, wherein the determining of whether the attributes match an entry of the entries in the security vulnerabilities information source comprises:
determining if not all the attributes are in the entry; and
determining the attributes match the entry if a majority of the attributes are in the entry.

11. The method of claim 1, wherein the determining of whether the attributes match an entry of the entries in the security vulnerabilities information source comprises:
determining text for one of the attributes is partially included in the entry; and
if the text for the one of the attributes is partially included in the entry, determining the one of the attributes is in the entry.

12. The method of claim 1, wherein the determining of whether the attributes match an entry of the entries in the security vulnerabilities information source comprises:
comparing one of the attributes to a hierarchal taxonomy in the security vulnerabilities information source; and
determining the one of the attributes is in the entry if a parent or child of the entry in the security vulnerabilities information source includes the one of the attributes.

13. A vulnerability management system comprising:
a vulnerability data management storage system; and
a processor executing:
an attribute extraction module to determine attributes of a test performed by a vulnerability assessment tool to detect a vulnerability, wherein the attributes are determined from information collected from the vulnerability assessment tool describing the test, and
a vulnerability assessment tool to compare the attributes with entries in a security vulnerabilities information source describing vulnerabilities and determine, from the comparison, whether the attributes match an entry of the entries in the security vulnerabilities information source for one of the vulnerabilities, and if a matching entry is determined, storing information from the matching entry with the collected information in the vulnerability management data storage system.

14. The vulnerability management system of claim 13, wherein the attributes comprise an identifier of a system that is vulnerable or causing the vulnerability, a vulnerability location, and a vulnerability type.

15. A non-transitory computer readable medium including machine readable instructions that when executed by a processor cause the processor to:
determine attributes of a test performed by a vulnerability assessment tool to detect a vulnerability, wherein the attributes are determined from information collected from the vulnerability assessment tool describing the test, and the attributes include an identifier of a system that is vulnerable or causing the vulnerability, a vulnerability location, and a vulnerability type;
determine whether the attributes match information for a vulnerability stored in a security vulnerabilities information source; and
if a matching entry is determined, store information from the matching entry with the collected information in a vulnerability management data storage system, wherein the stored information includes a vulnerability ID used by the security vulnerabilities information source to identify the vulnerability and an identification of a patch to remediate the vulnerability.
